(19) United States
(12) Patent Application Publication
(10) Pub. No.: US 2013/0343350 A1
(43) Pub. Date: Dec. 26, 2013

(54) SYNCHRONIZATION IN A COMMUNICATION SYSTEM

(71) Applicants: Uri Weinrib, Lod (IL); Keren Dor, Herzeliya (IL)

(72) Inventors: Uri Weinrib, Lod (IL); Keren Dor, Herzeliya (IL)

(21) Appl. No.: 13/528,209

(22) Filed: Jun. 20, 2012

(51) Int. Cl. H04W 56/00; H04J 3/06; H04W 72/04

(52) U.S. Cl. 370/336; 370/328

(57) ABSTRACT

One embodiment of the present invention includes a communication system. The communication system includes a plurality of multi-role wireless communication devices communicatively coupled to transmit and receive data between at least one network access point and between each other in a plurality of communication roles in a time-division multiplexed manner. At least one of the at least one network access point and at least one of the plurality of multi-role wireless communication devices can be configured to transmit a timing beacon configured to synchronize a time-division multiplexing of at least one corresponding communication role associated with each of the plurality of multi-role wireless communication devices.

### TECHNICAL FIELD

The present invention relates generally to communication systems, and specifically to synchronization in a communication system.

### BACKGROUND

IEEE 802.11 based wireless and mobile networks also called Wireless Fidelity (Wi-Fi) have experience rapid growth. Wi-Fi is a mechanism that allows an electronic device to exchange data wirelessly over a computer network. A device enabled with Wi-Fi, such as a personal computer, video game console, smart-phone, tablet, or digital audio player, can connect to a network resource such as the Internet via a wireless network access point. An access point (or hotspot) can have a range of about 22 meters (65 ft) indoors and a greater range outdoors. Hotspot coverage can comprise an area as small as a single room with walls that block radio signals or a large area, as much as many square miles, covered by multiple overlapping access points. A wireless access point (AP) connects a group of wireless devices to an adjacent wired LAN. An access point resembles a network hub, relaying data between connected wireless devices in addition to a (usually) single connected wired device, most often an Ethernet hub or switch, allowing wireless devices to communicate with other wired devices.

The various IEEE 802.11 standards provide for 14 possible channels distributed over a range from 2.402 GHz to 2.483 GHz with each channel being 24 MHz wide. The various IEEE 802.11 standards call for periodic channel scan cycles over at least a majority of the 14 channels to allow for communication handoffs between access points. Scanning can be divided into active and passive scanning. During an active scan, a station (STA) broadcasts a packet requesting that all access points (APs) in those specific channels impart their presence and capability with a probe response. In a passive scan, the STA listens passively for the AP beacons containing all necessary information, such as beacon interval, capability information, supported rate and other parameters associated with the AP.

A multi-role communication device allows a user to operate the device in a multi-role mode, where the device can operate in a plurality of communication roles for separate communication with multiple devices on the same channel (e.g., to act as both a station and an access point). The emerging desire for increased connectivity usage employing single multi-role devices requires support of wireless local area network (WLAN) concurrent multi-role operation on two bands/channels by a single Baseband processor. Therefore, the multi-role device can switch between providing resource allocation in a station mode and an access point mode, and/or can provide communication capability with other devices based on a direct communicative coupling. The communication between the access point and other communication devices can be accomplished based on different communication roles that can be time-division multiplexed.

### SUMMARY

In accordance with an aspect of the invention, a communication system is provided. The communication system includes a plurality of multi-role wireless communication devices communicatively coupled to transmit and receive data between at least one network access point and between each other in a plurality of communication roles in a time-division multiplexed manner. At least one of the at least one network access point and at least one of the plurality of multi-role wireless communication devices can be configured to transmit a timing beacon configured to synchronize a time-division multiplexing of at least one corresponding communication role associated with each of the plurality of multi-role wireless communication devices.

In accordance with another aspect of the invention, a multi-role wireless communication device is provided. The device includes a controller comprising a processor, memory, and a multi-role scheduler configured to implement a scheduling algorithm associated with time-division multiplexing of a plurality of communication roles for communication with at least one network access point and at least one other multi-role wireless communication device. The controller can be further configured to generate a timing beacon that is configured to synchronize a time-division multiplexing of at least one corresponding communication role associated with the at least one other multi-role wireless communication device with the scheduling algorithm. The device also includes at least one transceiver collectively configured to transmit and receive data in each of the plurality of communication roles based on the time-division multiplexing according to the scheduling algorithm and to periodically transmit the timing beacon at predetermined timing intervals.

In accordance with an aspect of the present invention, a method for synchronizing communications in a communication system comprising a plurality of multi-role wireless communication devices is provided. The method includes implementing a scheduling algorithm associated with time-division multiplexing of a plurality of communication roles in each of the plurality of multi-role wireless communication devices for communication of the plurality of multi-role wireless communication devices with each other and with at least one network access point. The method also includes transmitting a timing beacon comprising timing data associated with at least one of the plurality of communication roles to each of the plurality of multi-role wireless communication devices. The method also includes time-aligning the at least one corresponding communication role of each of the plurality of multi-role wireless communication devices based on the timing data. The method further includes transmitting and receiving data between the plurality of multi-role wireless communication devices at time slots associated with the at least one of the plurality of communication roles.

### BRIEF DESCRIPTION OF THE DRAWINGS

FIG. 1 illustrates an example of a communication system in accordance with an aspect of the present invention.

FIG. 2 illustrates an example timing diagram in accordance with an aspect of the invention.

FIG. 3 illustrates another example of a timing diagram in accordance with an aspect of the present invention.

FIG. 4 illustrates yet another example of a timing diagram in accordance with an aspect of the invention.

FIG. 5 illustrates yet a further example of a timing diagram in accordance with an aspect of the invention.

FIG. 6 illustrates an example of a multi-role wireless communication device in accordance with an aspect of the invention.

FIG. 7 illustrates an example of a method for synchronizing communications in a communication system in accordance with an aspect of the present invention.

### DETAILED DESCRIPTION

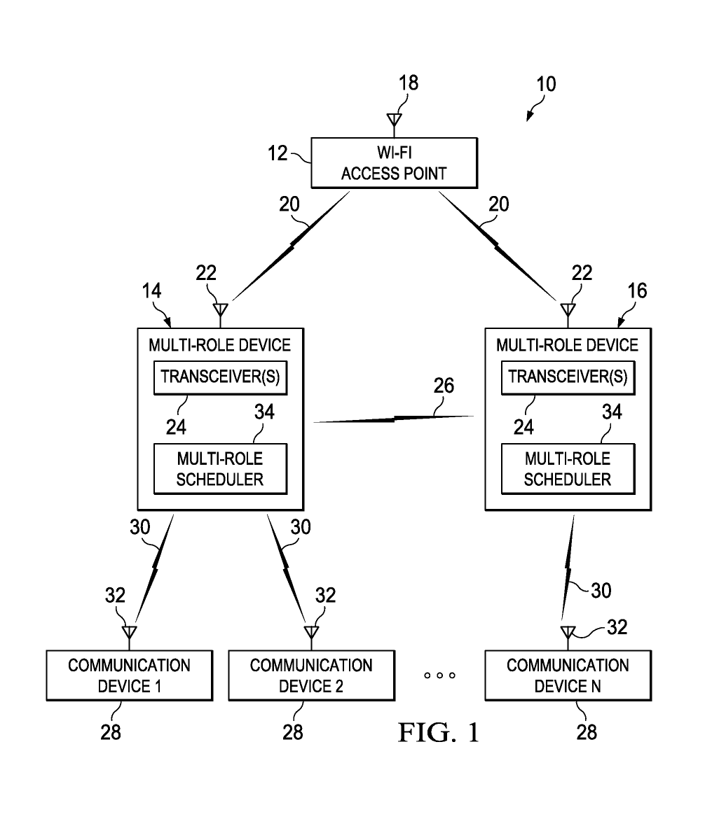

FIG. 1 illustrates an example of a communication system 10 in accordance with an aspect of the present invention. The communication system 10 comprises a Wireless Fidelity (Wi-Fi) access point (AP) 12 and a plurality of multi-role wireless communication devices, demonstrated in the example of FIG. 1, as a first multi-role wireless communication device 14 and a second multi-role wireless communication device 16. While the example of FIG. 1 demonstrates two multi-role wireless communication devices 14 and 16, it is to be understood that the communication system 10 can include more than the two multi-role wireless communication devices in the example of FIG. 1.

The multi-role wireless communication devices 14 and 16 can be configured to communicate via a plurality of different communication roles. As described herein, a “communication role” or “role” can be defined as communicating as a specific function of a wireless local area network (WLAN). Different communication roles can communicate with different communication protocols or over one of a plurality of channels within a given communication protocol. For example, a communication role can correspond to providing the function of communicating in a Wi-Fi WLAN station (STA) communication role, an access point communication role, a WLAN peer-to-peer communication role, or a Bluetooth (BT) File Transfer Protocol (FTP) communication role.

As an example, the wireless network system 10 can, at least in part, conform to one of the versions of the IEEE 802.11 standards for Wi-Fi networks. The Wi-Fi AP 12 can be configured to transmit radio frequency (RF) communications through an antenna 18 over respective wireless communication links 20 to one or both of the multi-role wireless communication devices 14 and 16 via an antenna 22 associated with each of the multi-role wireless communication devices 14 and 16. The Wi-Fi AP 12 and one or more other Wi-Fi APs (not shown) can be connected to the same or different wired networks (not shown). Additionally, while the example of FIG. 1 demonstrates that the multi-role wireless communication devices 14 and 16 are both communicatively coupled to the same Wi-Fi AP 12, it is to be understood that the multi-role wireless communication devices 14 and 16 could be coupled to separate Wi-Fi APs, including the Wi-Fi AP 12. As an example, the multi-role wireless communication devices 14 and 16 can perform periodic channel scans to determine which of a plurality APs to select to connect to and to receive resources from a given Wi-Fi network. An AP can be selected based on one or more communication parameters (e.g., capacity, signal strength, user selected, etc.) associated with the selected AP.

In the example of FIG. 1, the multi-role wireless communication devices 14 and 16 can function as STA devices when receiving resources from the Wi-Fi AP 12. As an example, the multi-role wireless communication devices 14 and 16 can be communicatively coupled to the Wi-Fi AP 12 via the respective communication links 20 based on a WLAN STA communication role. Therefore, as described previously, the multi-role wireless communication devices 14 and 16 can be configured to transmit and receive data respectively to and from the Wi-Fi AP 12 via the antenna 22, such as based on at least one transceiver 24. In addition, the multi-role wireless communication devices 14 and 16 are demonstrated as being communicatively coupled with each other via a communication link 26. For example, the multi-role wireless communication devices 14 and 16 can be communicatively coupled to each other based on a Wi-Fi WLAN P2P communication role. Therefore, the multi-role wireless communication devices 14 and 16 can be configured to transmit and receive data respectively between each other via the antenna 22 or via a separate antenna based on the transceiver(s) 24.

Additionally, in the example of FIG. 1, the communication system 10 also includes a plurality N of communication devices 28, where N is a positive integer. As an example, the communication devices 28 can correspond to any of a variety of wireless communication devices, laptop or tablet computers, or other devices. The communication devices 28 are demonstrated as communicatively coupled to the multi-role wireless communication devices 14 and 16 through communication links 30 via respective antennas 32. For example, the multi-role wireless communication devices 14 and 16 can be communicatively coupled to the communication devices 28 via the communication links 30 based on any of a variety of Wi-Fi WLAN communication roles and/or via BT FTP. As an example, the multi-role wireless communication devices 14 and 16 can function as APs to provide resources to one or more of the communication devices 28 acting as STA devices. It is to be understood that, while the communication devices 28 are demonstrated as coupled to both of the multi-role wireless communication devices 14 and 16, the communication devices 28 could instead be coupled to only one of the multi-role wireless communication devices 14 or 16, or to additional multi-role wireless communication devices in the communication system 10.

In the example of FIG. 1, the multi-role wireless communication devices 14 and 16 can operate in a multi-role mode to communicate with the Wi-Fi AP 12, the other multi-role wireless communication devices 14 and 16, and/or the communication devices 28 substantially concurrently using the same frequency channel. To operate in the multi-role mode, the multi-role wireless communication devices 14 and 16 can implement time-division multiplexing of a plurality of communication roles corresponding to the respective communication links 20, 26, and 30. For example, as described previously, the communication link 20 can correspond to a Wi-Fi WLAN STA role, the communication link 26 can correspond to a Wi-Fi WLAN P2P role, and the communication link 30 can correspond to a BT FTP role or any of a variety of other Wi-Fi WLAN roles. To implement the time-division multiplexing, each of the multi-role wireless communication devices 14 and 16 includes a multi-role scheduler 34 that is configured to implement a scheduling algorithm to independently arrange the time slots associated with the time-division multiplexing of the plurality of communication roles with which the multi-role wireless communication devices 14 and 16 communicate. Therefore, each of the multi-role wireless communication devices 14 and 16 can substantially concurrently transmit and receive data between each other, the Wi-Fi AP 12, and/or the communication devices 28. Furthermore, as described in greater detail herein, at least one of the Wi-Fi AP 12, the first multi-role wireless communication device 14, and the second multi-role wireless communication device 16 can be configured to transmit a timing beacon configured to synchronize the time-division multiplexing of the plurality of communication roles.

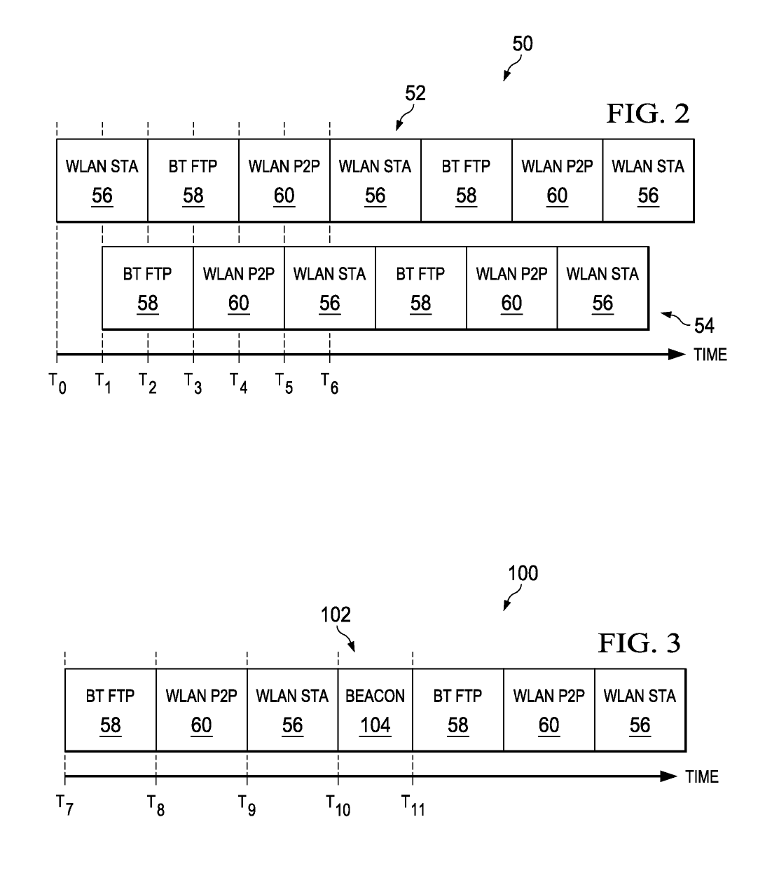

FIG. 2 illustrates an example timing diagram 50 in accordance with an aspect of the invention. The timing diagram 50 demonstrates the time-division multiplexing of a plurality of communication roles for each of the first and second multi-role wireless communication devices 14 and 16, demonstrated as a first time-division 52 and a second time-division 54, respectively. Therefore, reference can be made to the example of FIG. 1 in the following description of the example of FIG. 2. For example, the time-divisions 52 and 54 each demonstrate the timing of switching between the plurality of communication roles for each of the respective first and second multi-role wireless communication devices 14 and 16. In the example of FIG. 2, the communication roles include a Wi-Fi WLAN STA role 56, a BT FTP role 58, and a Wi-Fi WLAN STA role 60. For example, the multi-role scheduler 34 of the first and second multi-role wireless communication devices 14 and 16 can be configured to arrange the time slots of each of the respective first and second time-divisions 52 and 54 of the communication roles 56, 58, and 60.

At a time T₀, the first multi-role wireless communication device 14 switches to the Wi-Fi WLAN STA role 56. Thus, the first multi-role wireless communication device 14 is configured to communicate with the Wi-Fi AP 12 beginning at the time T₀. At a time T₁, the second multi-role wireless communication device 16 switches to the BT FTP role 58, such as associated with one or more of the communication links 30. Thus, the second multi-role wireless communication device 16 is configured to communicate with one or more of the communication devices 28 beginning at the time T₁. At a time T₂, the first multi-role wireless communication device 14 switches from the Wi-Fi WLAN STA role 56 to the BT FTP role 58. Therefore, at the time T₂, both of the first and second multi-role wireless communication devices 14 and 16 can communicate with the communication devices 28 via the respective communication links 30. Accordingly, in the example of FIG. 3, the first and second time-divisions 52 and 54 can be substantially misaligned (e.g., by a time difference of approximately T₁ minus T₀), such as based on the independent scheduling algorithms implemented by the multi-role schedulers 34 of the respective first and second multi-role wireless communication devices 14 and 16.

At a time T₃, the second multi-role wireless communication device 16 switches from the BT FTP role 58 to the Wi-Fi WLAN P2P role 60. Therefore, at the time T₃, the second multi-role wireless communication device 16 can be configured to communicate with the first multi-role wireless communication device 14. However, at the time T₃, the first multi-role wireless communication device 14 is still communicating via the BT FTP role 58. Therefore, any data packets that are being transmitted by the second multi-role wireless communication device 16 to the first multi-role wireless communication device 14 are not received by the first multi-role wireless communication device 14 because the at least one transceiver 24 of the first multi-role wireless communication device 14 is not configured to receive data of the Wi-Fi WLAN P2P role 60 at that time. As a result, the second multi-role wireless communication device 16 may not receive the appropriate acknowledgements to indicate successful receipt of the data packets at the first multi-role wireless communication device 14. Accordingly, the data packets not received by the first multi-role wireless communication device 14 may be continuously retransmitted by the second multi-role wireless communication device 16 until such acknowledgement is received.

At a time T₄, the first multi-role wireless communication device 14 switches from the BT FTP role 58 to the Wi-Fi WLAN P2P role 60. Therefore, at the time T₄, the first multi-role wireless communication device 14 can be configured to transmit and receive data to and from the second multi-role wireless communication device 16. The data packets that have been transmitted by the second multi-role wireless communication device 16 can now be acknowledged by the first multi-role wireless communication device 14, and the first multi-role wireless communication device 14 can then likewise transmit data packets to the second multi-role wireless communication device 16.

At a time T₅, the second multi-role wireless communication device 16 switches from the Wi-Fi WLAN P2P role 60 back to the Wi-Fi WLAN STA role 56 for communication with the Wi-Fi AP 12. However, at the time T₅, the first multi-role wireless communication device 14 remains set for communication in the Wi-Fi WLAN P2P role 60, but can no longer communicate with the second multi-role wireless communication device 16 based on the second multi-role wireless communication device 16 having switched to the Wi-Fi WLAN STA role 56. As a result, similar to as described previously, data packets transmitted by the first multi-role wireless communication device 14 are not received by the second multi-role wireless communication device 16, which is indicated by a lack of acknowledgements received by the first multi-role wireless communication device 14. Therefore, such data packets can be continuously retransmitted until a time T₆, at which the first multi-role wireless communication device 14 likewise switches back to the Wi-Fi WLAN STA role 56 and the time-divisions 52 and 54 repeat (i.e., as at the time T₀). Therefore, such data packets could be lost as a result of the first multi-role wireless communication device 14 switching to the Wi-Fi WLAN STA role 56, and/or based on expiration of an acknowledgement timer, resulting in a loss of connection between the first and second multi-role wireless communication devices 14 and 16.

Therefore, based on the respective independent scheduling of the communication roles 56, 58, and 60 by the multi-role schedulers 34 of the first and second multi-role wireless communication devices 14 and 16, the time-divisions 52 and 54 are substantially misaligned. Based on the misalignment of the time-divisions 52 and 54, the first and second multi-role wireless communication devices 14 and 16 have a window of mutual communication of a limited duration between the time T₅ and the time T₄, which is a window of time that is more narrow than a full time slot dedicated to communication in the Wi-Fi WLAN P2P role 60. Accordingly, the communication bandwidth between the first and second multi-role wireless communication devices 14 and 16 can be substantially limited based on the misalignment between the first and second time-divisions 52 and 54. In addition, if the misalignment between the time-divisions is large enough, there is a possibility of a communication link between the first and second multi-role wireless communication devices 14 and 16 being severed, such as based on expiration of an acknowledgement timer (e.g., too much time elapsed after transmission of a data packet without an acknowledgement). Furthermore, while the example of FIG. 2 demonstrates that the first and second time-divisions 52 and 54 have substantially the same order of communication roles with a slight offset (i.e., T₁ minus T₀), it is to be understood that the order on which the time slots of the communication roles are arranged can be different between the two time divisions 52 and 54, and that the Wi-Fi WLAN P2P roles 60 could be completely misaligned between the two time-divisions 52 and 54. Accordingly, communication between the first and second multi-role wireless communication devices 14 and 16 can be substantially limited.

Referring back to the example of FIG. 1, to substantially mitigate bandwidth limiting misalignment of the communications between the first and second multi-role wireless communication devices 14 and 16 (e.g., via the communication link 26), at least one of the Wi-Fi AP 12, the first multi-role wireless communication device 14, and the second multi-role wireless communication device 16 can be configured to transmit a timing beacon to substantially synchronize the time-divisions 52 and 54. For example, the timing beacon can include timing data associated with time slots arranged by the scheduling algorithm of the multi-role scheduler 34 of one of the multi-role wireless communication devices 14 and 16. The timing data can be, for example, time stamp information regarding the transitions of one or more of the communication roles based on the scheduling algorithm. For example, the time stamp information can be relative to a time stamp on a given packet or packets corresponding to the timing beacon, such that recipients of the timing beacon can identify when to switch to a relevant one of the communication roles to synchronize the time slots of the respective scheduling algorithm to the time slots of the scheduling algorithm of the transmitting device.

As an example, the first multi-role wireless communication device 14 can be configured as a group owner (GO) in a given communication session between the first and second multi-role wireless communication devices 14 and 16, such that the second multi-role wireless communication device 16 is configured as a client device. Therefore, the first and second multi-role wireless communication device 14, configured as the GO device, can act as a master with respect to the second multi-role wireless communication device 16, configured as the client device. Accordingly, the first multi-role wireless communication device 14 can transmit the timing beacon, such that the multi-role scheduler 34 of the second multi-role wireless communication device 16 can synchronize its scheduling algorithm to that of the scheduling algorithm of the multi-role scheduler 34 of the first multi-role wireless communication device 14.

As yet another example, the Wi-Fi AP 12 can be configured to transmit the timing beacon, such as via the communication links 20. As an example, the Wi-Fi AP 12 can transmit the timing beacon to all multi-role wireless communication devices to which it is communicatively coupled, such that the Wi-Fi AP 12 can dictate a time-division multiplexing scheme for all of the multi-role wireless communication devices (e.g., the multi-role wireless communication devices 14 and 16) with which it is coupled for synchronization of the time-division multiplexing schemes. As yet a further example, more than of the Wi-Fi AP 12 and/or the multi-role wireless communication devices 14 and 16 can periodically transmit timing beacons, such that each of the multi-role wireless communication devices 14 and 16 can incrementally adjust their respective time-divisions 52 and 54 forward or backward in time after each receipt of a timing beacon. As a result, the time-divisions 52 and 54 can eventually be substantially synchronized. Therefore, the timing beacon can be transmitted from any of a variety of devices in the communication system 10.

The timing beacon can be substantially periodically transmitted, such as to account for substantial differences in time-divisions and/or to accommodate new communication devices that are added to the communication system 10. For example, the periodic transmission of the timing beacon can occur at periodic predetermined time intervals (e.g., 100 millisecond intervals). As another example, the timing beacon can be transmitted after a predetermined number of transitions between different communication roles. At each transmission, the timing beacon can be transmitted according to one or more of the communication roles associated with the multi-role wireless communications devices 14 and 16. Therefore, it can be substantially assured that the timing beacon is received and processed by the respective multi-role wireless communications devices 14 and 16 regardless of the communication role with which they are communicating at the time of receipt of the timing beacon.

FIG. 3 illustrates another example of a timing diagram 100 in accordance with an aspect of the present invention. The timing diagram 100 demonstrates the time-division multiplexing of a plurality of communication roles. For instance, in the example of FIG. 3, the first multi-role wireless communication device 14 can be configured as a GO device in the communication system 10, such that the timing diagram demonstrates a time-division 102 that is arranged by the multi-role scheduler 34 of the multi-role wireless communication system 14. Therefore, reference can be made to the example of FIG. 1 in the following description of the example of FIG. 3. In the example of FIG. 3, like reference numbers are used as those in the example of FIG. 2, such that the communication roles include the Wi-Fi WLAN STA role 56, the BT FTP role 58, and the Wi-Fi WLAN P2P role 60.

At a time T₇, the multi-role wireless communication device 14 switches to the BT FTP role 58, such as associated with one or more of the communication links 30. Thus, the multi-role wireless communication device 14 is configured to communicate with one or more of the communication devices 28 beginning at the time T₇. At a time T₈, the multi-role wireless communication device 14 switches from the BT FTP role 58 to the Wi-Fi WLAN P2P role 60. Therefore, at the time T₈, the multi-role wireless communication device 14 can be configured to communicate with the other multi-role wireless communication devices, such as the multi-role wireless communication device 16. At a time T₉, the multi-role wireless communication device 14 switches from the Wi-Fi WLAN P2P role 60 to the Wi-Fi WLAN STA role 56. Thus, at the time T₉, the multi-role wireless communication device 14 can communicate with the Wi-Fi AP 12, such as via the communication link 20.

At a time T₁₀, the multi-role wireless communication device 14 can be configured to transmit a timing beacon 104. For example, the transmission of the timing beacon 104 can be based on expiration of a predetermined periodic time interval, or can be based on a predetermined number of communication role transitions. In the example of FIG. 3, the timing beacon 104 is demonstrated as being interleaved with the communication roles 56, 58, and 60, such that the transmission of the timing beacon 104 substantially interrupts the time-division 102 of the communication roles 56, 58, and 60. As an example, the timing beacon 104 can be configured as a plurality of data packets that include the timing data of the time-division 102, such as based on time stamps of imminent transitions to one or more of the communication roles 56, 58, and 60. Each of the plurality of data packets can be transmitted in a different one of the communication roles 56, 58, and 60, such that the data packets of the timing beacon 104 can be consecutively transmitted in each of the alternate communication roles 56, 58, and 60. Accordingly, regardless of the communication role with which the other multi-role wireless communication devices are communicating at the time T₁₀, the timing beacon 104 can be received, processed, and acknowledged. As another example, one or more of the other devices in the communication system 10, such as the Wi-Fi AP 12 and/or the communication devices 28 can be configured to retransmit the timing beacon 104 until it is received and acknowledged by the other multi-role wireless communication devices. As another example, the timing beacon 104 can be repeatedly transmitted in a single communication role until it is received and acknowledged by the other multi-role wireless communication devices. Alternatively, the timing beacon 104 can be transmitted a predetermined number of times at each predetermined interval, such that it does not need to be acknowledged by the multi-role wireless communication device 14.

At a time T₁₁, the multi-role wireless communication device 14 can switch back to the BT FTP role 58. Therefore, the multi-role wireless communication device 14 can again communicate with one or more of the communication devices 28 beginning at the time T₁₁, and thus the time division 102 can repeat switching between the sequence of communication roles 56, 58, and 60. At a future time, such as after expiration of a predetermined time interval or a predetermined number of transitions of the time-division 102, the multi-role wireless communication device 14 can again transmit the timing beacon 104, such as described previously.

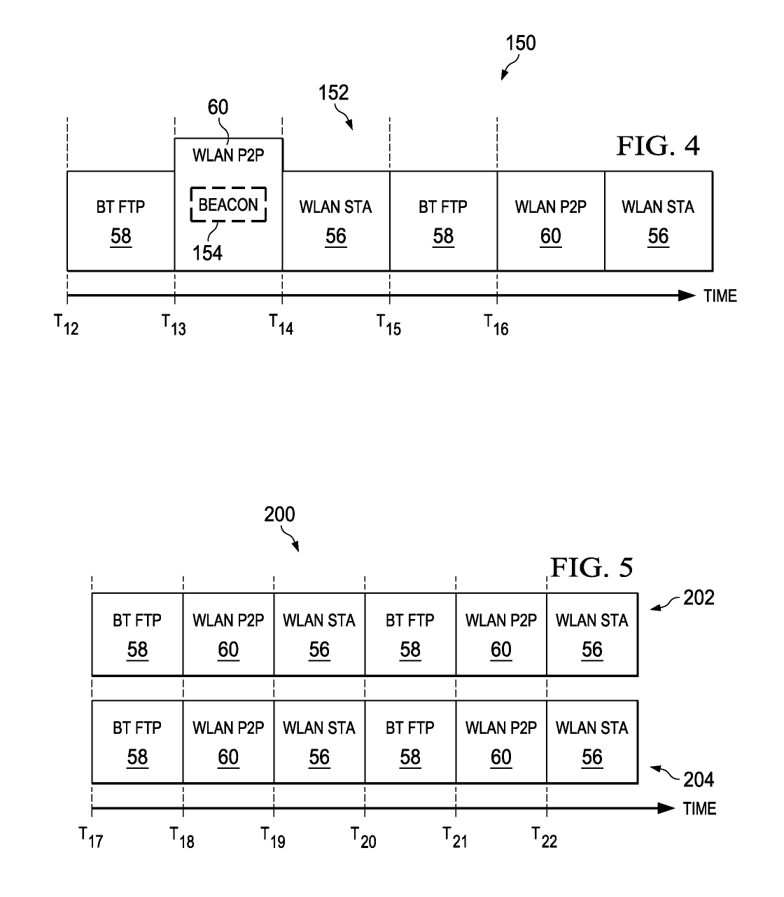

FIG. 4 illustrates yet another example of a timing diagram 150 in accordance with an aspect of the invention. The timing diagram 150 demonstrates the time-division multiplexing of a plurality of communication roles. For instance, in the example of FIG. 4, the first multi-role wireless communication device 14 can be configured as a GO device in the communication system 10, such that the timing diagram demonstrates a time-division 152 that is arranged by the multi-role scheduler 34 of the multi-role wireless communication system 14. Therefore, reference can be made to the example of FIG. 1 in the following description of the example of FIG. 4. In the example of FIG. 4, like reference numbers are used as those in the example of FIG. 2, such that the communication roles include the Wi-Fi WLAN STA role 56, the BT FTP role 58, and the Wi-Fi WLAN P2P role 60.

At a time T₁₂, the multi-role wireless communication device 14 switches to the BT FTP role 58, such as associated with one or more of the communication links 30. Thus, the multi-role wireless communication device 14 is configured to communicate with one or more of the communication devices 28 beginning at the time T₁₂. At a time T₁₃, the multi-role wireless communication device 14 switches from the BT FTP role 58 to the Wi-Fi WLAN P2P role 60. Therefore, at the time T₁₃, the multi-role wireless communication device 14 can be configured to communicate with the other multi-role wireless communication devices, such as the multi-role wireless communication device 16. In addition, in the example of FIG. 4, during the time slot beginning at the time T₁₃, the multi-role wireless communication device 14 transmits a timing beacon 154. Similar to as described previously, the transmission of the timing beacon 154 can be based on expiration of a predetermined periodic time interval, or can be based on a predetermined number of communication role transitions. In the example of FIG. 4, because the timing beacon 154 is demonstrated as being transmitted during the time slot associated with the Wi-Fi WLAN P2P role 60, the timing beacon 154 is transmitted in the Wi-Fi WLAN P2P role 60. As an example, the timing beacon 154 can be transmitted during a portion of the time slot beginning at the time T₁₃, such that the multi-role wireless communication device 14 can transmit and receive other data packets during the time slot beginning at the time T₁₃. As another example, the timing beacon 154 can be the only packet transmitted during the time slot beginning at the time T₁₃, such as transmitted one or more times, or continuously transmitted until an appropriate acknowledgement is received.

At a time T₁₄, the multi-role wireless communication device 14 switches from the Wi-Fi WLAN P2P role 60 to the Wi-Fi WLAN STA role 56. Thus, at the time T₁₄, the multi-role wireless communication device 14 can communicate with the Wi-Fi AP 12, such as via the communication link 20. At a time T₁₅, the multi-role wireless communication device 14 switches back to the BT FTP role 58, and at a time T₁₆, the multi-role wireless communication device 14 switches back to the Wi-Fi WLAN P2P role 60. In the example of FIG. 4, at the time T₁₆, the multi-role wireless communication device 14 can be configured to transmit and receive data to and from the multi-role wireless communication device 16 via the communication link 26, such as without transmitting another timing beacon 154. The time-division can thus continue to alternate between the communication roles 56, 58, and 60 until expiration of a predetermined time interval or number of transitions between the communication roles 56, 58, and 60, at which time the multi-role wireless communication device 14 can transmit another timing beacon 154. As an example, the next timing beacon could be transmitted during a time slot associated with a different communication role, such as the Wi-Fi WLAN STA role 56 or the BT FTP role 58. For example, the multi-role wireless communication device 14 could be configured to alternate between the communication roles 56, 58, and 60 at each consecutive transmission of the timing beacon 154, such as resulting from expiration of a predetermined time interval or number of transitions between the communication roles 56, 58, and 60.

FIG. 5 illustrates yet a further example of a timing diagram 200 in accordance with an aspect of the invention. The timing diagram 200 demonstrates the time-division multiplexing of the plurality of communication roles 56, 58, and 60 for each of the first and second multi-role wireless communication devices 14 and 16, demonstrated as a first time-division 202 and a second time-division 204, respectively. Therefore, reference can be made to the example of FIG. 1 in the following description of the example of FIG. 5. In the example of FIG. 5, the time-divisions 202 and 204 are each substantially aligned with respect to the communication roles 56, 58, and 60, such as in response to synchronization of the communication roles 56, 58, and 60 based on transmission of the timing beacon (e.g., the timing beacons 104 or 154 in the examples of FIGS. 3 and 4, respectively). Therefore, at each time slot, demonstrated as beginning at times T₁₇ through T₂₂, the multi-role wireless communication devices 14 and 16 each switch to a separate one of the communication roles 56, 58, and 60 substantially concurrently.

Therefore, the multi-role wireless communication devices 14 and 16 can achieve substantially more efficient communication with each other, such as via the communication link 26, based on alignment of the respective communication role (e.g., the Wi-Fi WLAN P2P role 60) with which they communication with each other. It is to be understood that, while the example of FIG. 5 demonstrates that at a given time in the timing diagram 200, the multi-role wireless communication devices 14 and 16 are demonstrated as communicating via the same one of the communication roles 56, 58, and 60, it is to be understood that the multi-role wireless communication devices 14 and 16 could communicate in different communication roles with respect to time slots that are devoted to communication with other devices on the network (e.g., the Wi-Fi AP 12 or the communication devices 28). Therefore, the synchronization of the communication roles 56, 58, and 60 could be with respect solely to the respective communication role (e.g., the Wi-Fi WLAN P2P role 60) with which the multi-role wireless communication devices 14 and 16 communication with each other, as opposed to all of the communication roles 56, 58, and 60.

It is to be understood that the communication system 10 is not limited to the examples demonstrated in the examples of FIGS. 1 through 5. For example, as described previously, the communication system 10 could include a plurality of Wi-Fi APs 12 and a plurality of additional multi-role wireless communication devices, as well as additional types of communication devices communicatively coupled with respect to them. Therefore, the synchronization of the communication roles as described herein can be implemented for any or all of the communication links 20, 24, and 28, as well as additional communication links that can be provided in the communication system 10. Therefore, the communication system 10 can be configured in a variety of ways.

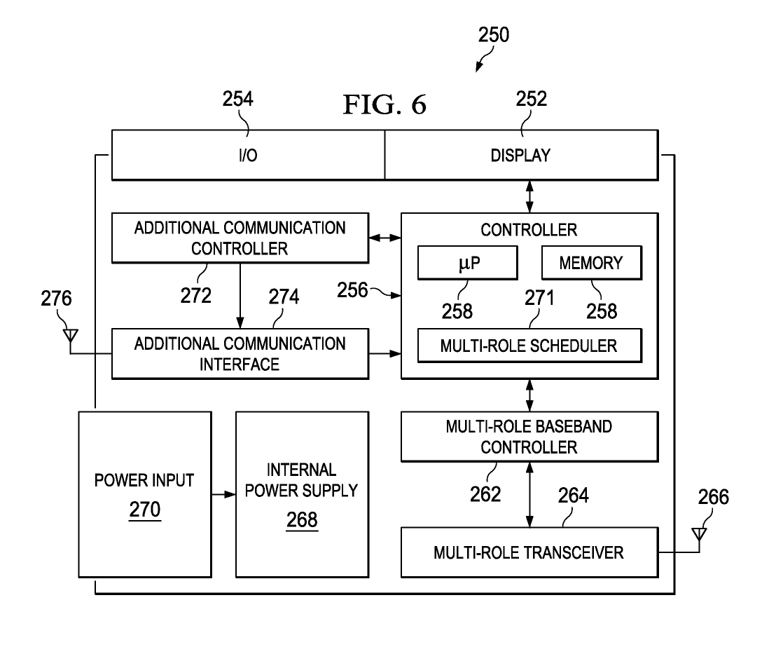

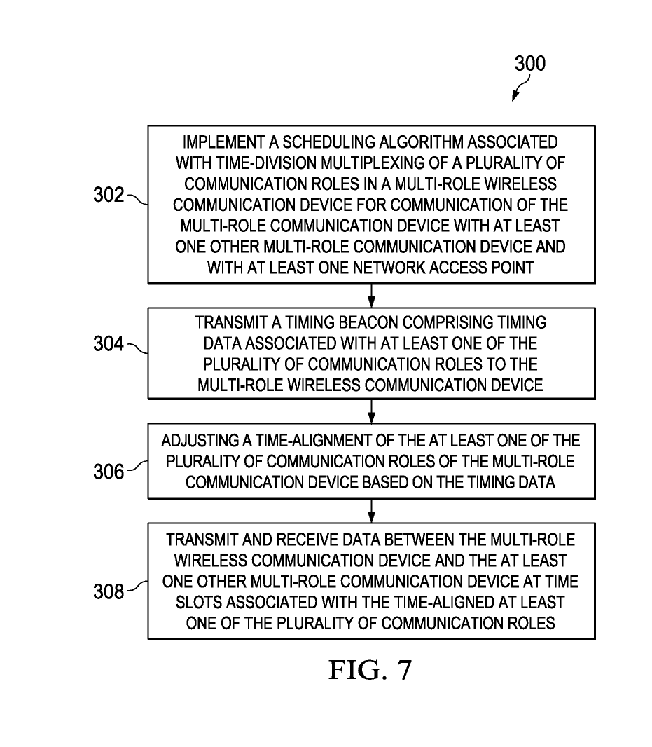

FIG. 6 illustrates a block diagram of an example of a multi-role wireless communication device 250 in accordance with an aspect of the invention. The multi-role wireless communication device 250 includes a display 252 that can be a touch screen or non-touch screen display. The display 252 could be operative to display media, gaming or website information, and could also be operative to receive touch inputs from a user, such as from a finger or a stylus. The multirole device 252 also includes input/output (I/O) devices 254, such as pushbuttons and LED indicators.

Both the display 252 and the I/O devices 254 are coupled to a controller 256. The controller 256 includes a microcontroller/microprocessor 258 (labeled as μP), a memory 260, and a multi-role scheduler 271. The user can input data into the multi-role wireless communication device 250 via the display 252 and/or the I/O devices 254. The data can be processed by the microcontroller/microprocessor 258 and/or stored in the memory 260. In addition, data can be retrieved from the memory 260 and displayed on the display 252. The multi-role scheduler 271 can be configured to implement a scheduling algorithm that is configured to arrange time slots associated with the time-division multiplexed manner of the plurality of communication roles with which the multi-role wireless communication device 250 can communicate.

The multi-role wireless communication device 250 further includes an internal power supply 268. The internal power supply 268 could be, for example, a rechargeable battery, such as a lithium ion battery. The internal power supply 268 is coupled to a power input 270, such that an external power supply (e.g., a DC power adaptor) could be plugged into the power input 270. The external power supply could thus supply power to the multi-role wireless communication device 250 while it is plugged into the power input 270, allowing the multi-role wireless communication device 250 to operate from the external power supply while the internal power supply 268 recharges.

The multi-role wireless communication device 250 includes a multi-role baseband controller 262 that operates to manage the separate roles of the multi-role wireless communication device 250 with respect to the communication roles with which the multi-role wireless communication device 250 can communicate. For example, the multi-role baseband controller 262 can operate in a Wi-Fi WLAN STA role, a BT FTP role, and a Wi-Fi WLAN STA role, as well as other communication roles. The multi-role baseband controller 262 is coupled to a multi-role transceiver 264 that is configured to up convert data from the multi-role baseband controller 262 to be transmitted to other wireless devices over an antenna 266, and down convert data received at the antenna 266 from other wireless devices and to be provided to the multi-role baseband controller 262. The multi-role baseband controller 262 is coupled to the controller 254, such that transmitted and received data can be processed by the microcontroller/microprocessor 258 and/or stored in the memory 260.

The multi-role baseband controller 262 manages the functionality associated with transmitting, receiving and time multiplexing data between the communication roles of the multi-role wireless communication device 250, such as based on the scheduling algorithm set by the multi-role scheduler 271. Therefore, the multi-role baseband controller 262 can allow the multi-role wireless communication device 250 to communicate with other wireless communication devices, such as Wi-Fi APs, other multi-role wireless communication devices, and other communication devices, based on a plurality of different communication roles.

The multi-role wireless communication device 250 can also include an additional communication controller 72 coupled to an additional communication transceiver 74. The additional communication transceiver 74 is coupled to an antenna 76 for transmitting and receiving communications over other communication networks such as a cellular network (e.g., 3G network, 4G network, etc.). Additional communication controllers and transceivers can be provided for other communication network, such as, for example, IEEE 802.15 (i.e., Bluetooth).

As an example, the multi-role baseband controller 262 can be configured to generate a timing beacon signal, such as generated by the microcontroller/microprocessor 258. The timing beacon can be configured to synchronize the time-division multiplexing of communication roles of other multi-role wireless communication devices with the time-division of the multi-role wireless communication device 250, as set by the multi-role scheduler 271. For example, the timing beacon can include timing data, such as time stamps, associated with the transitions associated with one or more of the communication roles, such as dictated by the multi-role scheduler 271. Therefore, the multi-role wireless communication device 250 can periodically transmit the timing beacon, such as based on predetermined timing intervals or communication role transitions, when operating as a GO device to enable other multi-role wireless communication devices to synchronize their respective communication role time-divisions with the time-division of the multi-role wireless communication device 250. As another example, the multi-role baseband controller 262 can be configured to receive a timing beacon from another wireless communication device, such as another multi-role wireless communication device. As a result, the multi-role scheduler 271 can synchronize the time slots of one or more of the communication roles to the time-division of the transmitting communication device based on the timing beacon. Accordingly, the time-division of one or more of the communication roles of the multi-role wireless communication device 250 can be substantially synchronized with the transmitting communication device.

In view of the foregoing structural and functional features described above, certain methods will be better appreciated with reference to FIG. 6. It is to be understood and appreciated that the illustrated actions, in other embodiments, may occur in different orders and/or concurrently with other actions. Moreover, not all illustrated features may be required to implement a method.

FIG. 6 illustrates an example of a method 300 for synchronizing communications in a communication system. At 302, a scheduling algorithm associated with time-division multiplexing of a plurality of communication roles is implemented in a multi-role wireless communication device for communication of the multi-role wireless communication device with at least one other multi-role communication device and with at least one network access point. The scheduling algorithm can be based on a multi-role scheduler in each of the multi-role wireless communication devices. As an example, the communication roles can include a Wi-Fi WLAN STA role, a BT FTP role, and a Wi-Fi WLAN STA role. At 304, a timing beacon comprising timing data associated with at least one of the plurality of communication roles is transmitted to the multi-role wireless communication device. The timing beacon can be transmitted from one or more of the devices on the communication system, such as a multi-role wireless communication device acting as a GO device. The timing data can include time-stamps associated with transitions of the communication roles.

At 306, a time-alignment of the at least one of the plurality of communication roles of the multi-role wireless communication device is adjusted based on the timing data. The timing alignment can occur based on synchronization of the other communication devices to the device that transmitted the timing signal. At 308, data between the multi-role wireless communication device and the at least one other multi-role communication device is transmitted and received at time slots associated with the time-aligned at least one of the plurality of communication roles. The time slots can be associated with a Wi-Fi WLAN P2P communication role.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A communication system comprising:
a plurality of multi-role wireless communication devices communicatively coupled to transmit and receive data between at least one network access point and between each other in a plurality of communication roles in a time-division multiplexed manner, at least one of the at least one network access point and at least one of the plurality of multi-role wireless communication devices being configured to transmit a timing beacon configured to synchronize a time-division multiplexing of at least one corresponding communication role associated with each of the plurality of multi-role wireless communication devices.

2. The system of claim 1, wherein the plurality of communication roles comprises at least two of peer-to-peer, Wi-Fi station, and Bluetooth.

3. The system of claim 1, wherein each of the plurality of multi-role wireless communication devices comprises a multi-role scheduler configured to arrange time slots associated with the time-division multiplexed manner of the plurality of communication roles for a respective one of the plurality of multi-role wireless communication devices.

4. The system of claim 1, wherein the at least one of the at least one network access point and the at least one of the plurality of multi-role wireless communication devices is configured to periodically transmit the timing beacon at predetermined timing intervals that are interleaved with the time-division multiplexing of the plurality of communication roles.

5. The system of claim 1, wherein the timing beacon comprises time stamp data associated with switching between each of the plurality of communication roles.

6. The system of claim 1, wherein the timing beacon is transmitted by one of the plurality of multi-role devices acting as a group owner (GO) with respect to a remaining at least one of the plurality of multi-role devices.

7. The system of claim 1, wherein the timing beacon is transmitted as a plurality of packets consecutively transmitted according to each of the respective plurality of communication roles.

8. The system of claim 1, wherein the timing beacon is transmitted at time slots associated with at least one of the plurality of communication roles, the timing beacon comprising time stamp data associated with switching between the respective at least one of the plurality of communication roles associated with a respective one of the time slots during which the timing beacon is transmitted.

9. The system of claim 1, further comprising at least one additional communication device communicatively coupled to at least one of the plurality of multi-role devices via one of the plurality of communication roles, the at least one of the plurality of multi-role devices corresponding to an intermediate access point for the at least one additional communication device.

10. A multi-role wireless communication device comprising:
a controller comprising a processor, memory, and a multi-role scheduler configured to implement a scheduling algorithm associated with time-division multiplexing of a plurality of communication roles for communication with at least one network access point and at least one other multi-role wireless communication device, the controller being further configured to generate a timing beacon that is configured to synchronize a time-division multiplexing of at least one corresponding communication role associated with the at least one other multi-role wireless communication device with the scheduling algorithm; and
at least one transceiver collectively configured to transmit and receive data in each of the plurality of communication roles based on the time-division multiplexing according to the scheduling algorithm and to periodically transmit the timing beacon at predetermined timing intervals.

11. The device of claim 10, wherein the plurality of communication roles comprises at least two of peer-to-peer, Wi-Fi, and Bluetooth.

12. The device of claim 10, wherein periodic transmission of the timing beacon at the predetermined timing intervals is interleaved with the time-division multiplexing of the plurality of communication roles.

13. The device of claim 10, wherein the timing beacon comprises time stamp data associated with switching between each of the plurality of communication roles according to the scheduling algorithm.

14. The device of claim 10, wherein the timing beacon is transmitted as a plurality of packets that are consecutively transmitted according to each of the respective plurality of communication roles.

15. The device of claim 10, wherein the timing beacon is periodically transmitted at the predetermined timing intervals in time slots associated with at least one of the plurality of communication roles based on the time-division multiplexing according to the scheduling algorithm, the timing beacon comprising time stamp data associated with switching between the respective at least one of the plurality of communication roles associated with a respective one of the time slots during which the timing beacon is transmitted.

16. A method for synchronizing communications in a communication system, the method comprising:
implementing a scheduling algorithm associated with time-division multiplexing of a plurality of communication roles in a multi-role wireless communication device for communication of the multi-role wireless communication device with at least one other multi-role communication device and with at least one network access point;
transmitting a timing beacon comprising timing data associated with the at least one of the plurality of communication roles to the multi-role wireless communication device;
adjusting a time-alignment of the at least one of the plurality of communication roles of the multi-role wireless communication device based on the timing data; and
transmitting and receiving data between the multi-role wireless communication device and the at least one other multi-role communication device at time slots associated with the time-alignment adjusted at least one of the plurality of communication roles.

17. The method of claim 16, wherein transmitting the timing beacon comprises periodically transmitting the timing beacon at predetermined timing intervals that are interleaved with the time-division multiplexing of the plurality of communication roles.

18. The method of claim 16, wherein transmitting the timing beacon comprises transmitting the timing beacon comprising time stamp data associated with switching between the at least one of the plurality of communication roles according to the scheduling algorithm.

19. The method of claim 16, wherein transmitting the timing beacon comprises consecutively transmitting a plurality of packets according to each of the respective plurality of communication roles.

20. The method of claim 16, wherein transmitting the timing beacon comprises is periodically transmitting the timing beacon at predetermined timing intervals in time slots associated with at least one of the plurality of communication roles based on the time-division multiplexing according to the scheduling algorithm, the timing beacon comprising time stamp data associated with switching to the respective at least one of the plurality of communication roles associated with a respective one of the time slots during which the timing beacon is transmitted.
